(19) United States
(12) Patent Application Publication
(10) Pub. No.: US 2026/0031015 A1
(43) Pub. Date: Jan. 29, 2026

(54) DISPLAY SYSTEM

(71) Applicant: Prilit Optronics, Inc., Tainan City (TW)

(72) Inventors: Biing-Seng Wu, Tainan City (TW); Tzung-Ren Wang, Tainan City (TW)

(21) Appl. No.: 18/787,866

(22) Filed: Jul. 29, 2024

(51) Int. Cl. G09G 3/32; G09G 3/20

(52) U.S. Cl. CPC G09G 3/32; G09G 3/2096; G09G 2310/08; G09G 2330/021

(57) ABSTRACT

A display system includes a display panel divided into a plurality of display blocks arranged in rows and columns, each display block including a plurality of micro-light-emitting diodes (microLEDs) driven by a corresponding driver disposed in a corresponding display block; a power management unit (PMU) that dynamically provides different power-supply voltages for the drivers respectively during a line scan period or a frame scan period; and a timing controller that determines the different power-supply voltages for the PMU according to content of data to be display on the display panel.

### BACKGROUND OF THE INVENTION

### 1. Field of the Invention

The present invention generally relates to a display system, and more particularly to power management of the display system.

### 2. Description of Related Art

A micro-light-emitting diode (microLED, mLED or μLED) display panel is one of flat display panels, and is composed of microscopic microLEDs each having a size of 1-100 micrometers. Compared to conventional liquid crystal display panels, the microLED display panels offer better contrast, response time and energy efficiency. Although both organic light-emitting diodes (OLEDs) and microLEDs possess good energy efficiency, the microLEDs, based on group III/V (e.g., GaN) LED technology, offer higher brightness, higher luminous efficacy and longer lifespan than the OLEDs.

Conventional microLED display systems may adopt a pulse-width modulation (PWM) scheme, which generates a PWM signal, a duty cycle of which is proportional to brightness (or intensity) of the data to be provided to the microLED display panel.

Conventional microLED display systems, either adopting or not adopting the PWM scheme, greatly suffer low power efficiency due to varying loading with constant power supply.

A need has thus arisen to propose a novel scheme to overcome the drawbacks of the conventional microLED display systems.

### SUMMARY OF THE INVENTION

In view of the foregoing, it is an object of the embodiment of the present invention to provide a display system capable of dynamically providing different power-supply voltages for the drivers respectively, thereby effectively improving overall power efficiency of the display panel.

According to one embodiment, a display system includes a display panel, a power management unit (PMU) and a timing controller. The display panel is divided into a plurality of display blocks arranged in rows and columns, each display block including a plurality of micro-light-emitting diodes (microLEDs) driven by a corresponding driver disposed in a corresponding display block. The PMU dynamically provides different power-supply voltages for the drivers respectively during a line scan period or a frame scan period. The timing controller determines the different power-supply voltages for the PMU according to content of data to be display on the display panel.

### BRIEF DESCRIPTION OF THE DRAWINGS

FIG. 1 shows a schematic diagram illustrating a display panel divided into a plurality of display blocks arranged in rows and columns according to one embodiment of the present invention;

FIG. 2 shows a bock diagram illustrating a display system according to one embodiment of the present invention;

FIG. 3 shows an exemplary timing diagram of the data signals of the display system of FIG. 2;

FIG. 4A and FIG. 4B show block diagrams illustrating a display system according to one embodiment of the present invention; and

FIG. 5 shows a simplified circuit diagram illustrating series-connected resistances that make up the total equivalent resistance.

### DETAILED DESCRIPTION OF THE INVENTION

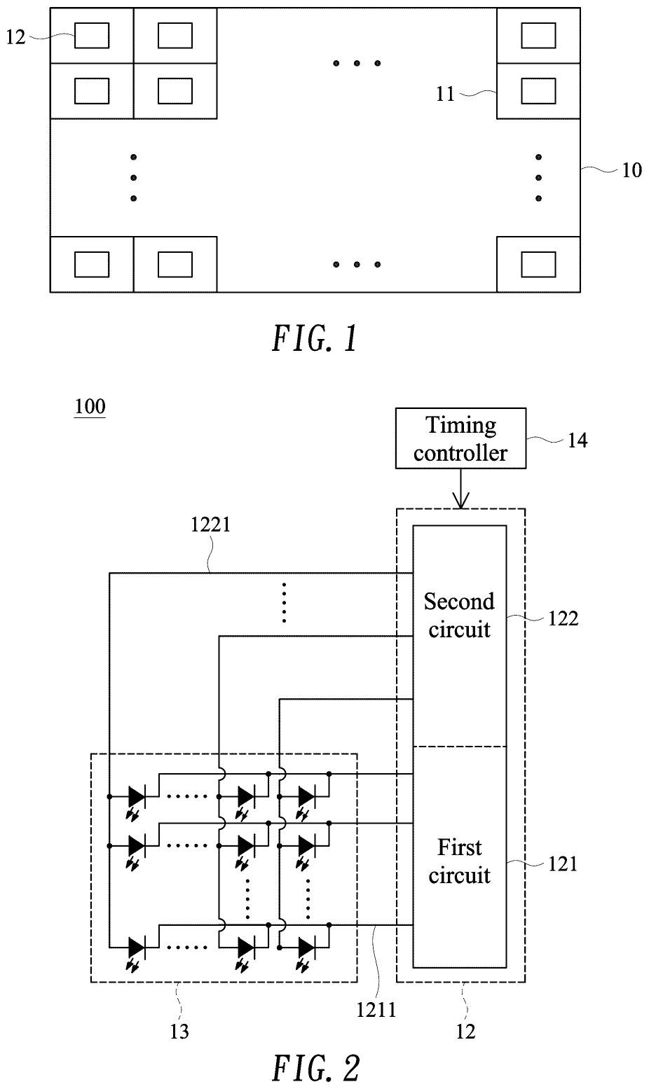

FIG. 1 shows a schematic diagram illustrating a display panel 10 divided into a plurality of display blocks 11 arranged in rows and columns according to one embodiment of the present invention. Specifically, each display block 11 may include a plurality of micro-light-emitting diodes or microLEDs (not shown) driven by a corresponding driver 12 disposed in a corresponding display block 11.

FIG. 2 shows a bock diagram illustrating a display system 100 according to one embodiment of the present invention. Specifically, the driver 12 may include a first circuit 121 configured to turn on at least one row of corresponding microLEDs 13 at a time via scan lines 1211. The driver 12 may include a second circuit 122 configured to provide data signals (that are pulse-width modulated) to the turned-on row of microLEDs 13 via data lines (or channels) 1221. It is noted that a duty cycle of each pulse-width modulation (PWM) data signal is proportional to brightness of corresponding data to be displayed on the display panel 10.

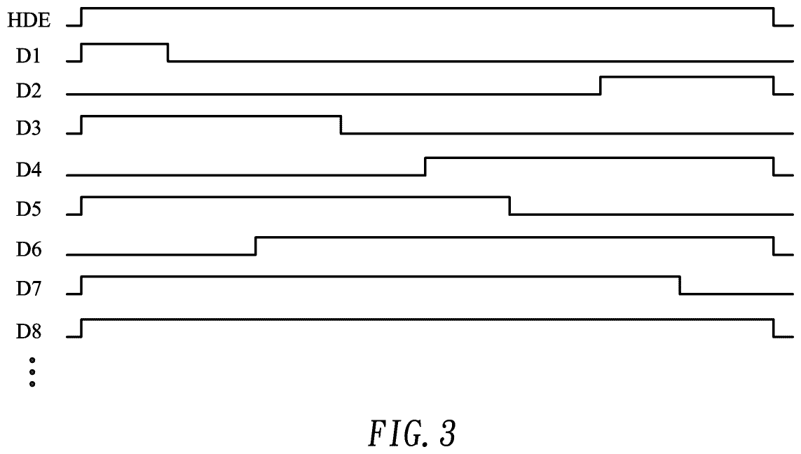

FIG. 3 shows an exemplary timing diagram of the data signals of the display system 100 of FIG. 2. Specifically, a (horizontal) line scan signal HDE defines a line scan period for scanning one (turned-on) row of the microLEDs 13. As exemplified in the timing diagram, data signals of odd-numbered data lines are provided at a beginning of the line scan period, and data signals of even-numbered data lines are provided at an end of the line scan period. Therefore, not all the data lines provide data signals at the same time, thereby preventing peak power consumption at the beginning of the line scan period.

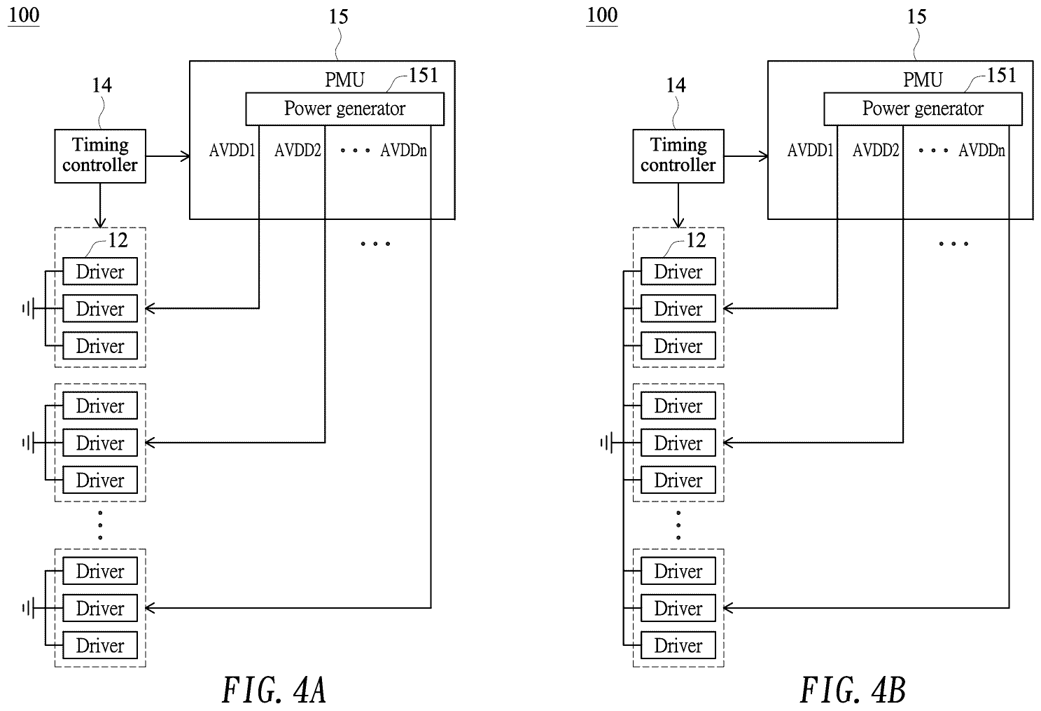

FIG. 4A and FIG. 4B show block diagrams illustrating a display system 100 according to one embodiment of the present invention. In the embodiment, the drivers 12 (of the display panel 10) may be arranged into groups (e.g., every three drivers 12 are grouped together as exemplified in FIG. 4A/4B). It is noted that, in consideration of resistance associated with the ground, the drivers 12 may be grounded group by group respectively as exemplified in FIG. 4A, or may be grounded together as exemplified in FIG. 4B.

According to one aspect of the embodiment, the display system 100 may include a power management unit (PMU) 15, which may include a power generator 151 configured to dynamically provide a plurality of different power-supply voltages AVDD1-AVDDn for the groups of drivers 12 respectively during a line scan period (for scanning one line) or a frame scan period (for scanning one frame).

In the embodiment, the display system 100 may include a timing controller 14 configured to determine total current required by a corresponding group of drivers 12 according to duty cycles of the PWM data signals (i.e., data content) during the line or frame scan period. The power-supply voltage AVDDx (x=1 to n) may be determined by the timing controller 14 according to total current required by the corresponding group of drivers 12 during a line or frame scan period such that a corresponding power-supply voltage AVDDx with least value can afford the required total current for the corresponding group of drivers 12 (during the line or frame scan period). The determined power-supply voltages AVDD1-AVDDn are then fed to the PMU 15, which accordingly generates the power-supply voltages AVDD1-AVDDn. Accordingly, overall power efficiency of the display panel 10 can be effectively improved.

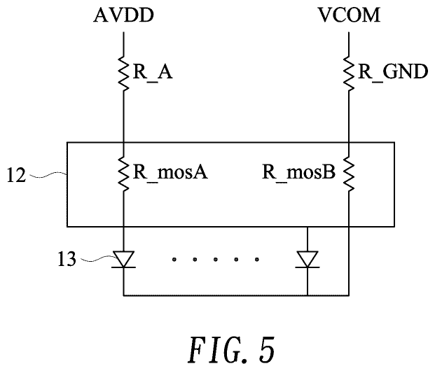

FIG. 5 shows a simplified circuit diagram illustrating series-connected (electrical) resistances that make up the total equivalent resistance. Specifically, the series-connected resistances may include (1) resistance R_A of an external conductive wire (e.g., disposed on a printed circuit board) between an input power pad of the driver 12 and an output power pad of the PMU 15 that provides the power-supply voltage AVDD; (2) equivalent internal resistance R_mosA associated with the input power pad of the driver 12; (3) equivalent internal resistance R_mosB associated with a common power pad of the driver 12; and (4) resistance R_GND of an external conductive wire (e.g., disposed on the printed circuit board) between the common power pad of the driver 12 and a common voltage node VCOM.

The determined total current is then multiplied by total equivalent resistance plus voltage drop of the microLED 13 to obtain the power-supply voltage AVDD for the corresponding group of drivers 12 during the line or frame scan period, and may be expressed as follows:

$$AVDD = Vd + I\_total \times ( R\_A + R\_mosA + R\_mosB + R\_GND )$$

where Vd represents the voltage drop of the microLED 13, and I_total represents total current required by the corresponding group of drivers 12.

According to the embodiment as described above, as data signals are pulse-width modulated according to brightness of corresponding data, the brightness of data (i.e., data content) affects the total current I_total, which in turn affects the power-supply voltage AVDD. Accordingly, the power-supply voltage AVDD can be adaptively adjusted according to data content, and overall power efficiency of the display panel 10 can be effectively improved.

Although specific embodiments have been illustrated and described, it will be appreciated by those skilled in the art that various modifications may be made without departing from the scope of the present invention, which is intended to be limited solely by the appended claims.

1. A display system, comprising:
a display panel divided into a plurality of display blocks arranged in rows and columns, each display block including a plurality of micro-light-emitting diodes (microLEDs) driven by a corresponding driver disposed in a corresponding display block;
a power management unit (PMU) that dynamically provides different power-supply voltages for the drivers respectively during a line scan period or a frame scan period; and
a timing controller that determines the different power-supply voltages for the PMU according to content of data to be display on the display panel.

2. The system of claim 1, wherein the PMU comprises:
a power generator that generates the different power-supply voltages.

3. The system of claim 1, wherein the drivers of the display panel are arranged into groups.

4. The system of claim 3, wherein each power-supply voltage is determined according to total current required by a corresponding group of drivers during the line scan period or the frame scan period such that a corresponding power-supply voltage with least value can afford the required total current for the corresponding group of drivers.

5. The system of claim 4, wherein the timing controller determines the total current required by the corresponding group of drivers according to duty cycles of pulse-width modulation (PWM) data signals during the line scan period or the frame scan period.

6. The system of claim 5, wherein the power-supply voltage is obtained by multiplying the total current by a total equivalent resistance plus voltage drop of a microLED.

7. The system of claim 6, wherein the total equivalent resistance comprises the following series-connected resistances:
resistance of an external conductive wire between an input power pad of the driver and an output power pad of the PMU that provides the power-supply voltage;
equivalent internal resistance associated with the input power pad of the driver;
equivalent internal resistance associated with a common power pad of the driver; and
resistance of an external conductive wire between the common power pad of the driver and a common node.

8. The system of claim 4, wherein the timing controller determines the total current required by the corresponding group of drivers according to data signals, and each power-supply voltage of a corresponding group of drivers is determined according to the determined total current.

9. The system of claim 3, wherein the drivers are grounded group by group respectively.

10. The system of claim 3, wherein the drivers are grounded together.

11. The system of claim 1, wherein the driver comprises:
a first circuit that turns on at least one row of corresponding microLEDs at a time; and
a second circuit that provides PWM data signals to the turned-on row of microLEDs;
wherein a duty cycle of each PWM data signal is proportional to brightness of corresponding data to be displayed on the display panel.
